(19) United States
(12) Patent Application Publication
(10) Pub. No.: US 2013/0112449 A1
(43) Pub. Date: May 9, 2013

(54) TORSION INCREASING PNEUMATIC TOOL PERCUSSION HAMMER

(71) Applicant: Kuo-Jung LU, Taichung City (TW)

(72) Inventor: Kuo-Jung LU, Taichung City (TW)

(73) Assignee: SING HUA INDUSTRIAL CO., LTD., Taichung City (TW)

(21) Appl. No.: 13/292,625

(22) Filed: Nov. 9, 2011

(51) Int. Cl. B25D 17/00

(52) U.S. Cl. 173/126

(57) ABSTRACT

A pneumatic tool percussion hammer features motion ends of the percussion block of the percussion hammer with added configuration of a mass increasing part. The mass increasing part can help to increase the mass of the motion ends of the percussion block without increasing the overall size of the percussion block. Hence, the present invention can effectively increase the inertia force of the percussion block in motion, and consequently the torsion and instant acceleration of the percussion hammer, without the need to increase the overall size of the percussion hammer.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a pneumatic tool percussion hammer structure, and more particularly to an innovative torsion increasing percussion hammer.

2. Description of Related Art Including Information Disclosed Under 37 CFR 1.97 and 37 CFR 1.98.

The functions of various pneumatic tools are based on torsion generated by the pneumatic power. For example, a pneumatic spanner is mainly used to fasten or loosen large-sized nuts or bolts. Because such large-sized nuts or bolts require a high fastening torsion, the pneumatic spanner must generate sufficient torsion to be capable of the operation.

Said pneumatic spanner usually generates torsion through the configuration of a percussion seat. Inside the percussion seat, one or two block-shaped percussion hammers are housed and restrained. The hammers will have an inertia motion along with the stops of positive or negative revolving of the driving axle, and generate a torsion-increasing percussion force.

Based on existing designs, the torsion generated by the pneumatic spanner usually depends on the size of the percussion hammers, because larger and heavier percussion hammers will naturally generate higher inertia acting force. However, in this way, the overall size of the pneumatic spanner must be enlarged to meet the demand of higher torsion. This is obviously a problem and bottleneck for production as well as usage.

For the users, a small-sized pneumatic spanner is easier to operate and is obviously more convenient and practical. Hence, it is obviously a goal and target for the manufacturers to further increase the functional torsion of the pneumatic spanner while maintaining its relatively small size, so as to meet the expectation of users.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

The present invention mainly features the innovative and unique design of the motion ends of the percussion block of the percussion hammer with added configuration of the mass increasing part. Comparing to the known structures disclosed in the prior art, the mass increasing part can help to increase the mass of the motion ends of the percussion block without increasing the overall size of the percussion block. Hence, the design of the present invention can effectively increase the inertia force of the percussion block in motion, and consequently the torsion and instant acceleration of the percussion hammer, without the need to increase the overall size of the percussion hammer. This is an obvious advantage and practical advancement.

As a supplement to the above descriptions, taking the pneumatic spanner product shown in FIGS. 2 and 3 for example, if the output torsion of a prior-art pneumatic spanner of the same specifications is 350 ft-lbs, with adoption of the design disclosed by the present invention, the output torsion will increase by about 100 ft-lbs to 450 ft-lbs. Moreover, the instant acceleration time to reach the preset torsion will decrease from 5 seconds to 3 seconds. This is a preliminary testing result by the inventor and is for reference only.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is an exploded perspective view of a preferred embodiment of the percussion hammer structure of the present invention.

FIG. 2 is an exploded perspective view of the percussion hammer of the present invention implemented in a pneumatic tool.

FIG. 3 is an assembled perspective view of the percussion hammer of the present invention implemented in a pneumatic tool.

FIG. 4 is a perspective view of the mass increasing part of the present invention being a projecting block integrally extending from the motion end of the percussion block.

FIG. 5 is a perspective view of the mass increasing part of the present invention being independently made and locked onto the motion end of the percussion block.

FIG. 6 is a perspective view of the mass increasing part of the present invention being of a heavier material and embedded in the motion end of the percussion block.

FIG. 7 is a perspective view of the mass increasing part of the present invention configured on both motion ends.

FIG. 8 is a schematic view of the mass increasing part of the present invention differently configured on the two motion ends.

### DETAILED DESCRIPTION OF THE INVENTION

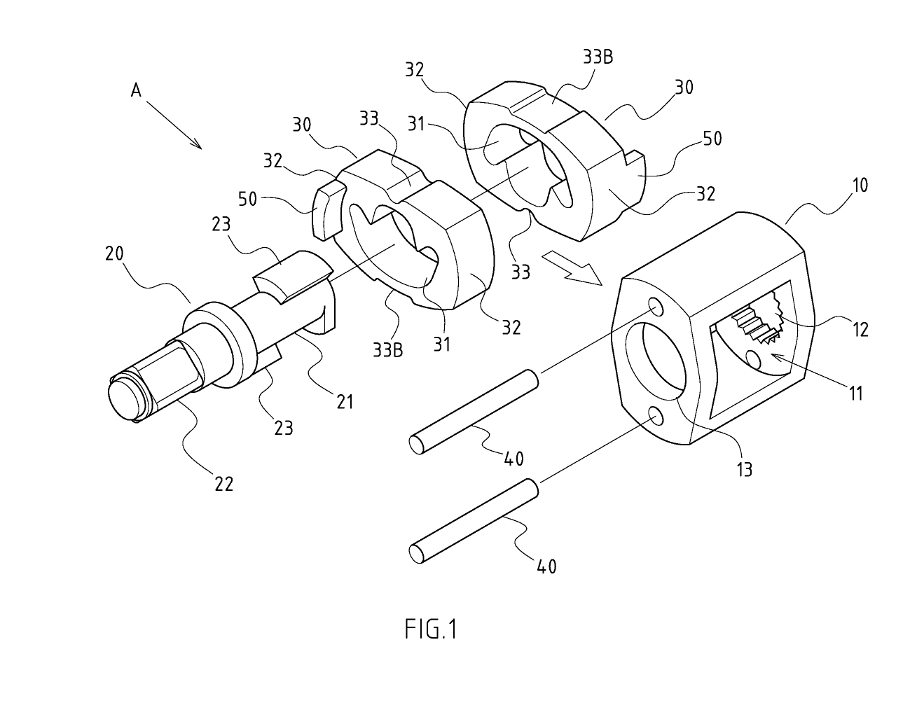

FIG. 1 depicts a preferred embodiment of the torsion increasing pneumatic tool percussion hammer structure of the present invention. However, it is to be understood that, such an embodiment is illustrative only, and is not intending to be limiting to the scope of patent application. The pneumatic tool using said percussion hammer can be a pneumatic spanner.

The percussion hammer A comprises a percussion seat 10, being a hollow frame, comprising of a percussion block housing space 11 and a croze hole 12 and an axle through hole 13 configured on the two opposite side walls of the percussion block housing space 11.

A driving axle 20 has a driving end 21 and a tool end 22 (can be a quadrangular prism), wherein, the driving end 21 goes through the axle through hole 13 of the percussion seat 10 and is housed in the percussion block housing space 11. The driving end 21 has a driving rib 23. The tool end 22 projects out of the axle through hole 13 of the percussion seat 10 as the part to fasten or loosen the bolt.

At least one percussion block 30 (this embodiment has two) is housed inside the percussion block housing space 11 of the percussion seat 10 and is movable. Said percussion block 30 comprises an irregular through hole 31 and two motion ends 32. The irregular through hole 31 is to be matched and fitted by the driving end 21 of the driving axle 20. Further, the two opposite sides of the percussion block 30 are respectively configured with a supporting concave edge 33 and a motion limiting concave edge 33B.

Two fixation pins 40 go through and are fitted on the two opposite sides of the percussion block housing space 11 of the percussion seat 10. If viewing from the percussion block 30, one of the fixation pins 40 goes through the supporting concave edge 33 configured on the percussion block 30, while the other fixation pins 40 goes through the motion limiting concave edge 33B configured on the percussion block 30.

A mass increasing part(s) 50 is configured on the motion end 32 of the percussion block 30. Said mass increasing part 50 is to increase the mass of the motion end 32 of the percussion block 30.

Based on the above structure, the mass increasing part 50 can increase the inertia acting force of the percussion block 30 in motion, so as to increase the torsion and instant acceleration of the percussion hammer A, without the need to increase the overall size of the percussion hammer.

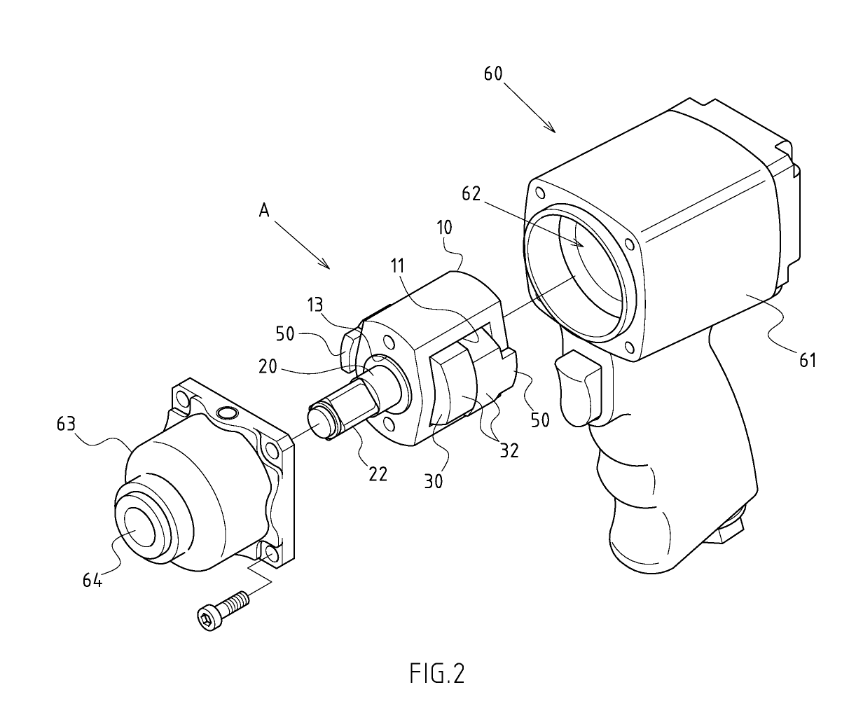

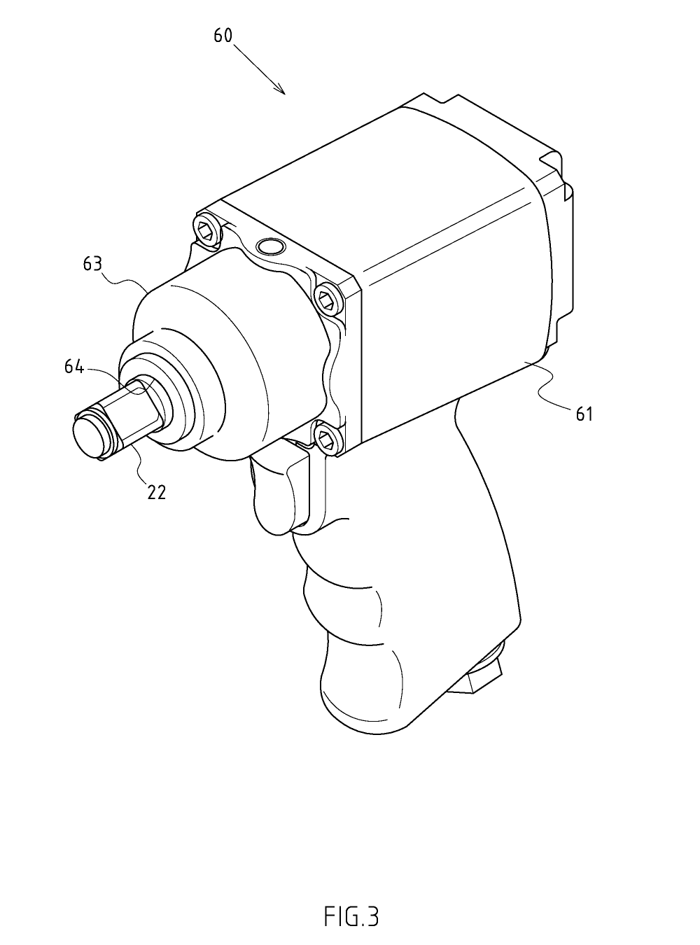

FIGS. 2 and 3 depict an implementation of the percussion hammer A in a pneumatic tool. In this implementation, the pneumatic tool is a pneumatic spanner 60. The percussion hammer A is fitted into a driving slot 62 preset in the main body 61 of the pneumatic spanner 60, and then covered and limited by a shell cover 63. The center of the shell cover 63 is configured with a through hole 64 for the tool end 22 configured on the driving axle 20 of the percussion hammer A to go through and out (as shown in FIG. 3). Further, a driving stud shaft is configured inside the driving slot 62 (omitted in the drawing) to perfectly mesh with the croze hole 12 configured on the percussion seat 10, so as to drive the percussion hammer A to rotate.

Particularly, the embodiment of said mass increasing part 50 (as depicted in FIG. 4) can be a projecting block integrally extending from the motion end 32 of the percussion block 30.

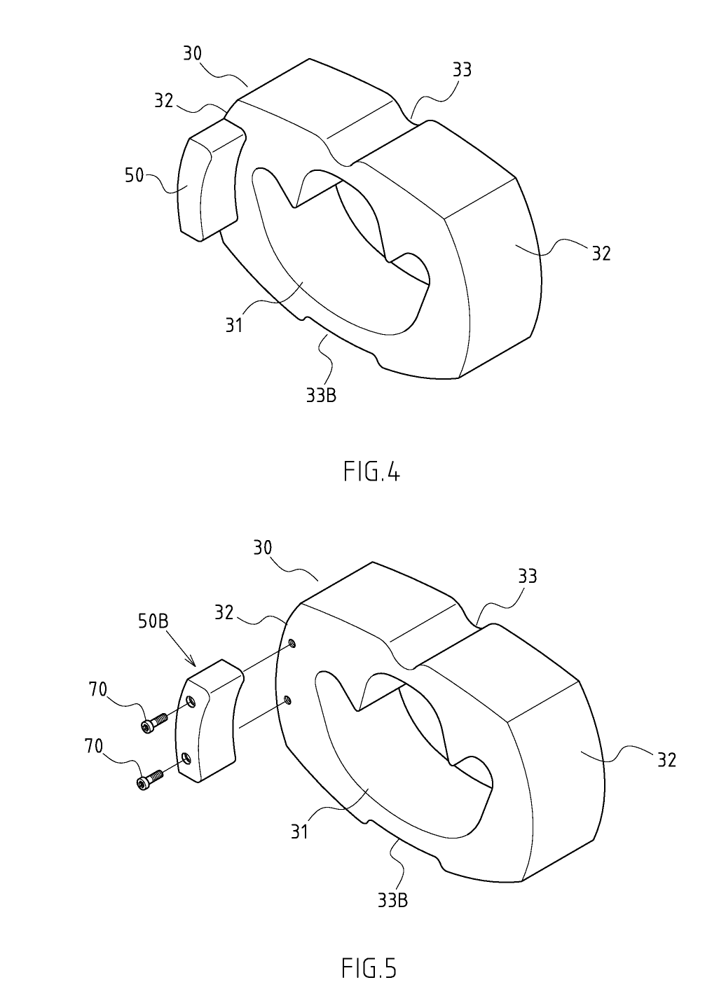

Alternatively, as shown in FIG. 5, the mass increasing part 50B is independently made and then locked (for instance, through bolts 70) or combined (for instance, through welding) onto the motion end 32 of the percussion block 30.

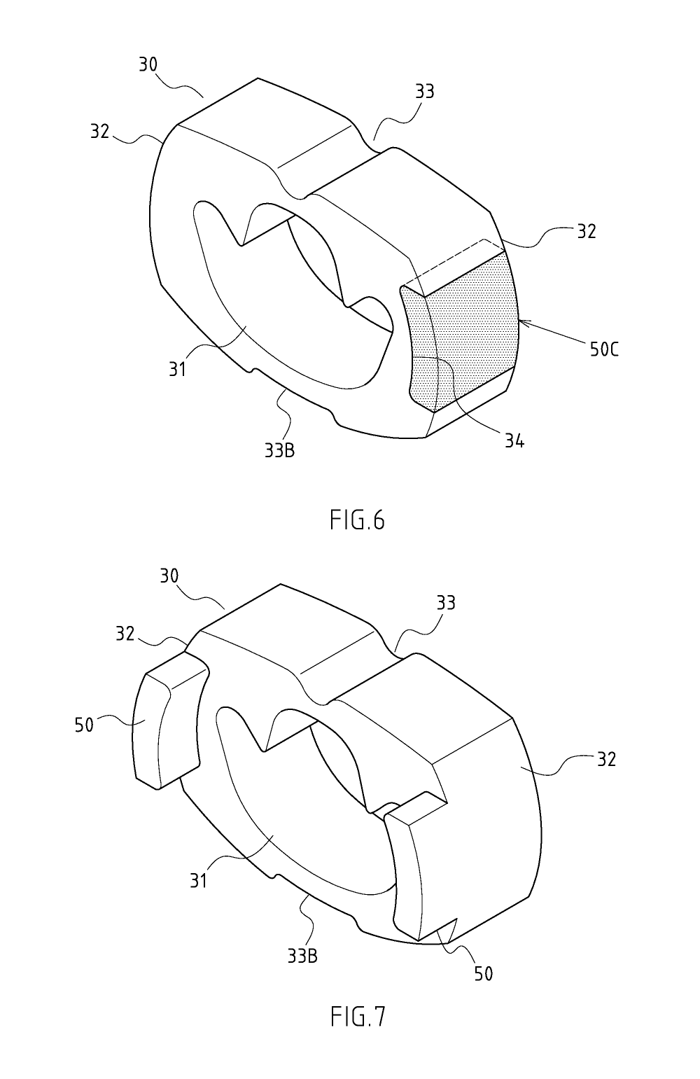

Further, as shown in FIG. 6, the mass increasing part 50C is of a heavier material comparing to the percussion block 30, and the motion end 32 of the percussion block 30 is configured with an embedding part 34 for the mass increasing part 50C to be inserted or embedded.

Moreover, said mass increasing part 50 can be configured on either of the two motion ends 32 of the percussion block 30 (as shown in FIG. 4). Or, as shown in FIG. 7, a mass increasing part 50 is configured on both of the two motion ends 32. Configuration of the mass increasing part 50 on one motion end 32 only or on both of the two motion ends 32 will depend on the inertia increasing effect demanded by the industry, and is not limited.

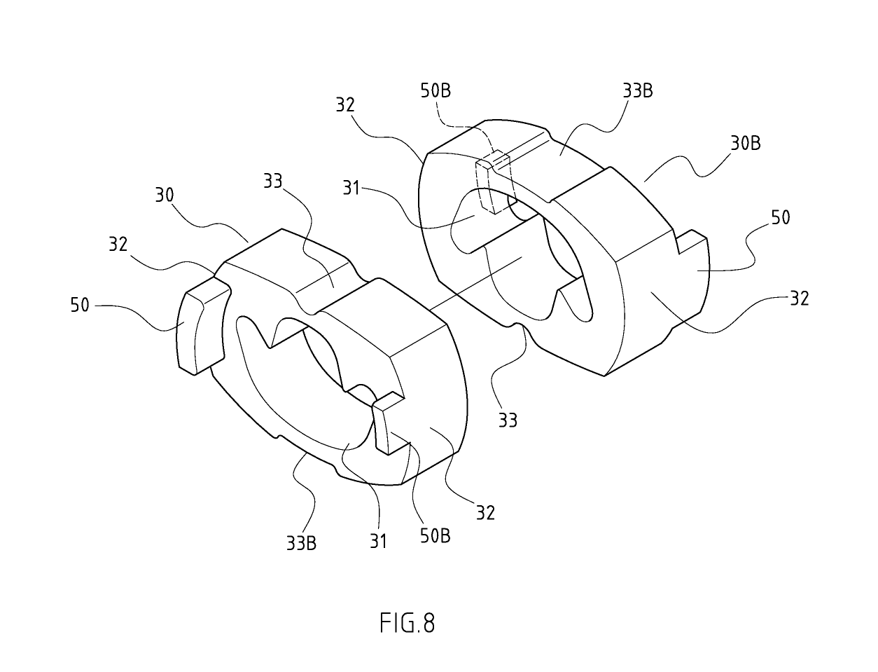

Referring to FIG. 8, when two percussion blocks 30, 30B are configured, it will be a preferred embodiment if the mass increasing part 50 on the different percussion blocks 30, 30B are configured symmetrically in a balanced state according to the rotation need. On the two different percussion blocks 30, 30B depicted in this drawing, the two motion ends 32 are configured respectively with two different-sized mass increasing parts 50, 50B, so that the percussion blocks 30, 30B will exert different inertia force during positive and negative rotation, but the mass increasing part 50 and mass increasing part 50B must be configured in a balanced and symmetrical manner on the two percussion blocks 30, 30B (i.e., balanced diagonally) so as to keep balance and stability during operation.

Moreover, when two percussion blocks 30, 30B are configured, the different mass increasing parts 50, 50B configured on the motion ends 32 of the percussion block 30, 30B can be of different mass (as shown in FIG. 8), and be fitted in the percussion block housing space 11 of the percussion seat 10 according to the need for mass increase in the positive or negative rotating direction, so as to provide different inertia force.

1. A torsion increasing pneumatic tool percussion hammer structure wherein said percussion hammer comprises:
a percussion seat, being a hollow frame, comprising a percussion block housing space and a croze hole and an axle through hole configured on the two opposite side walls of the percussion block housing space;
a driving axle, comprising a driving end and a tool end, wherein, the driving end goes through the axle through hole of the percussion seat and is housed in the percussion block housing space, and the driving end has a driving rib; the tool end projects out of the axle through hole of the percussion seat;
at least one percussion block, housed inside the percussion block housing space of the percussion seat and is movable; said percussion block comprises an irregular through hole and two motion ends; the irregular through hole is to be matched and fitted by the driving end of the driving axle; the two opposite sides of the percussion block are respectively configured with a supporting concave edge and a motion limiting concave edge;
two fixation pins, going through and fitted on the two opposite sides of the percussion block housing space of the percussion seat; the two fixation pins respectively goes through the supporting concave edge and motion limiting concave edge configured on the percussion block, so as to limit the rotation of the percussion block;
at least one mass increasing part, configured on the motion end of the percussion block; said mass increasing part is to increase the mass of the motion end of the percussion block;
such a configuration can increase the inertia acting force of the percussion block in motion, so as to increase the torsion and instant acceleration of the percussion hammer, without the need to increase the overall size of the percussion hammer.

2. The structure defined in claim 1, wherein said mass increasing part is a projecting block integrally extending from the motion end of the percussion block.

3. The structure defined in claim 1, wherein said mass increasing part is independently made and then combined or locked onto the motion end of the percussion block.

4. The structure defined in claim 1, wherein said mass increasing part is of a heavier material than the percussion block.

5. The structure defined in claim 1, wherein the motion end of the percussion block is configured with an embedding part, for the mass increasing part to be inserted or embedded.

6. The structure defined in claim 1, wherein said mass increasing part is configured on either or both of the two motion ends of the percussion block.

7. The structure defined in claim 1, wherein, when two percussion blocks are configured, the mass increasing part on the different percussion blocks are configured symmetrically in a balanced state according to the rotation need.

8. The structure defined in claim 1, wherein, when two percussion blocks are configured, the different mass increasing parts configured on the motion ends of the percussion block can be of different mass, and be fitted in the percussion block housing space of the percussion seat according to the need for mass increase in the positive or negative rotating direction, so as to provide different inertia force.
